(19) United States
(12) Patent Application Publication
(10) Pub. No.: US 2007/0151825 A1
(43) Pub. Date: Jul. 5, 2007

(54) Lever arrangement for friction clutches

(76) Inventors: Robin Christopher Boninfante, Yeadon, PA (US); Nicholas John Boninfante SR., Yeadon, PA (US)

Correspondence Address: Alan G. Towner;Pietragallo, Bosick & Gordon LLP, One Oxford Centre, 38th Floor, 301 Grant Street, Pittsburgh, PA, 15219, US

(21) Appl. No.: 11/326,233

(22) Filed: Jan. 5, 2006

(51) Int. Cl. F16D 13/48

(52) U.S. Cl. 192/105 C; 192/70.29; 192/70.3

(57) ABSTRACT

Clutch actuating lever arrangements for friction clutches are disclosed. The actuating levers are circumferentially spaced and are pivotally mounted on a clutch cover and a pressure ring. The pivotable actuating levers extend inwardly at angles offset from the radial direction of the clutch. As the rate of rotation of the clutch accelerates, the angled levers pivot due to centrifugal force to increase actuating pressure through the pressure clutch. The clutch may be disengaged by applying pressure to release tips of the levers. The angled lever arrangement provides a higher lever ratio for engagement and disengagement of the pressure ring, and provides even plate loads at optimal locations on the pressure ring.

### CROSS-REFERENCE TO RELATED APPLICATION

This application claims the benefit of U.S. Provisional Patent Application Ser. No. ______ entitled “Method of Clutch Lever Design for Friction Clutch Units” naming Robin Christopher Boninfante and Nicholas John Boninfante, Sr. as inventors, which was mailed by First Class mail to the U.S. Patent and Trademark Office on Jan. 4, 2005 and has a filing date of January ______ , 2005, and which is incorporated herein by reference.

### FIELD OF THE INVENTION

The present invention relates generally to vehicle clutches, and more particularly relates to clutch actuating lever arrangements for friction clutches.

### BACKGROUND INFORMATION

Clutches for vehicles are used to couple and decouple an engine to a drive shaft. Examples of prior art friction clutches are disclosed in U.S. Pat. Nos. 4,989,711 and 5,785,163, which are incorporated herein by reference. In such designs, clutch actuating levers are pivotally mounted on a pressure ring by devises and pins that allow each lever to centrifugally apply pressure to the pressure ring through its respective clutch clevis. A clutch clevis is a part of a friction clutch unit that provides support for the clutch lever and bolts to the clutch pressure ring. The pressure ring applies pressure to friction discs and steel plates. These components are attached to a clutch cover, which in turn is attached to a flywheel. The flywheel and clutch cover may be provided as a unit that is bolted directly to the back of a vehicle crankshaft. The clutch unit allows the vehicle to gradually move from a standing start by allowing the clutch to slip, thereby preventing the engine of the vehicle from stalling or straining, or preventing the drive tires from losing traction by applying too much power to the driveline.

Currently, actuating levers used in friction clutch units extend radially inward from the pressure ring toward the axial center of the clutch unit. Although effective, such radially aligned lever designs have shortcomings including limited gain in lever ratio, which prevents the clutch units from performing to their potential. Furthermore, the current radial lever design severely limits the diameter of clutch units that can be built. Because it is important that the lever and clevis apply an even plate load to the pressure ring, current designs prevent the manufacture of smaller, lighter and more efficient clutch designs.

Also, on smaller diameter clutch designs, the current radial levers cause uneven pressure applied from the lever through the clevis to the pressure ring because pressure is applied on the outer diameter of the pressure ring. This off-center pressure may cause permanent damage to the flatness of the pressure ring, which degrades operation of the clutch assembly. Because it is important for the pressure ring to remain flat throughout its life for maximum performance, a deformed or bent pressure ring causes a decrease in performance.

From the foregoing, it can be appreciated that there exists a need for a friction clutch actuating lever design that allows a gain in lever ratio while still providing the desired direct pressure from the lever to the clevis to the pressure ring without damage to the flat surface of the pressure ring, which in turn allows the design of smaller, lighter and more efficient clutch units.

### SUMMARY OF THE INVENTION

The present invention provides an angled clutch actuating lever arrangement which allows friction clutches to gain greater amounts of lever ratio to the clutch pressure ring. The angled levers and their respective devises apply direct pressure at optimal locations on the pressure ring to achieve direct and even plate load through the levers to the pressure ring. Benefits of the present invention include increased lever ratios, the application of even plate loads to the clutch pressure ring, the reduction or elimination of flexing and permanent damage to the flatness of the pressure ring, the ability to produce smaller and lighter clutch units, and reduced effort in lifting of the pressure ring for disengagement of the clutch.

The present invention provides an efficient and effective friction clutch design. In one embodiment of the invention, each lever is pivotally attached to the clutch cover and to the pressure ring, and extends inwardly at an angle offset from the radial direction of the clutch unit, e.g., at an angle greater than 0° and less than 90° with respect to the radial direction. Because the levers are attached at such angles, additional lever ratio is obtained, and smaller, lighter and more efficient clutch units can be designed without compromising cross-directional load and proper direct pressure to the pressure ring. The present design reduces or eliminates the flexing that distorts or bends the pressure ring, while reducing the clutch peddle pressure required for clutch disengagement.

An aspect of the present invention is to provide a clutch cover and pressure ring assembly comprising a generally annular clutch cover having a central axis, a generally annular pressure ring having a central axis substantially aligned with the central axis of the clutch cover, wherein the clutch cover and pressure ring are rotatable with each other around their central axes and axially movable with respect to each other, and at least one actuating lever pivotally mounted on the clutch cover and/or pressure ring and extending radially inward at an angle offset from a radial direction of the clutch cover and pressure ring.

Another aspect of the present invention is to provide an annular clutch cover having a central axis and comprising a plurality of slots structured and arranged for receiving actuating levers, wherein each slot extends radially inward at an angle offset from a radial direction of the clutch cover.

A further aspect of the present invention is to provide an annular clutch pressure ring having a central axis and comprising a plurality of recesses structured and arranged to receive actuating levers, wherein each recess is oriented at an angle offset from a radial direction of the pressure ring.

These and other aspects of the present invention will be more apparent from the following description.

### BRIEF DESCRIPTION OF THE DRAWINGS

FIG. 1 is an isometric sectional view of a friction clutch cover and pressure ring assembly with angled actuating levers in accordance with an embodiment of the present invention. The levers are pivotally connected to the clutch cover and pressure ring at angles offset from the radial direction which allows the levers to achieve a greater lever ratio.

FIG. 2 is a top view of the friction clutch cover and pressure ring assembly of FIG. 1.

FIG. 3 is a bottom view of the friction clutch cover and pressure ring assembly of FIG. 1.

FIG. 4 is an exploded isometric view of the friction clutch cover and pressure ring assembly of FIG. 1.

FIG. 5 is a top view of a clutch cover in accordance with an embodiment of the present invention.

FIG. 6 is a bottom view of the clutch cover of FIG. 5.

FIG. 7 is a bottom view of a clutch pressure ring in accordance with an embodiment of the present invention.

### DETAILED DESCRIPTION

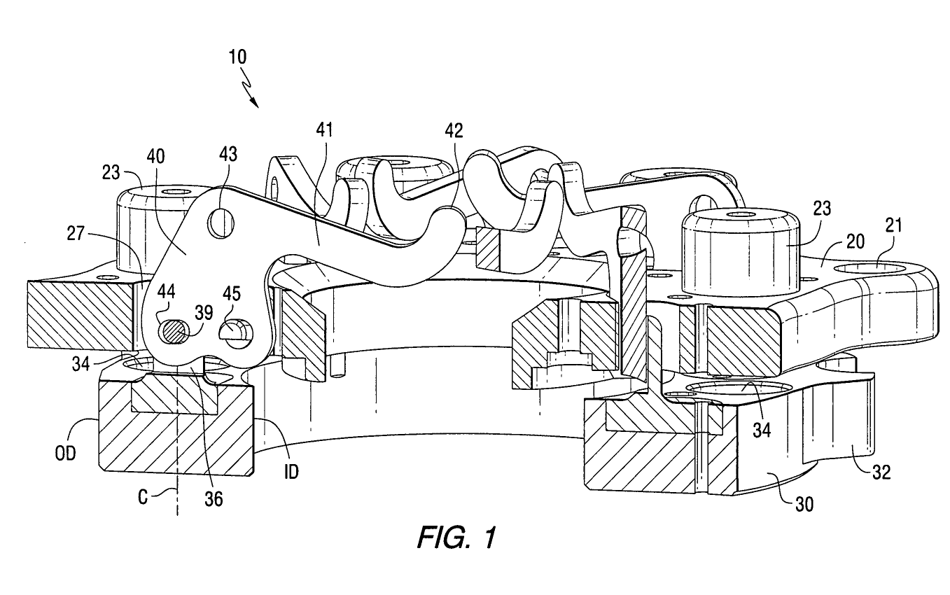

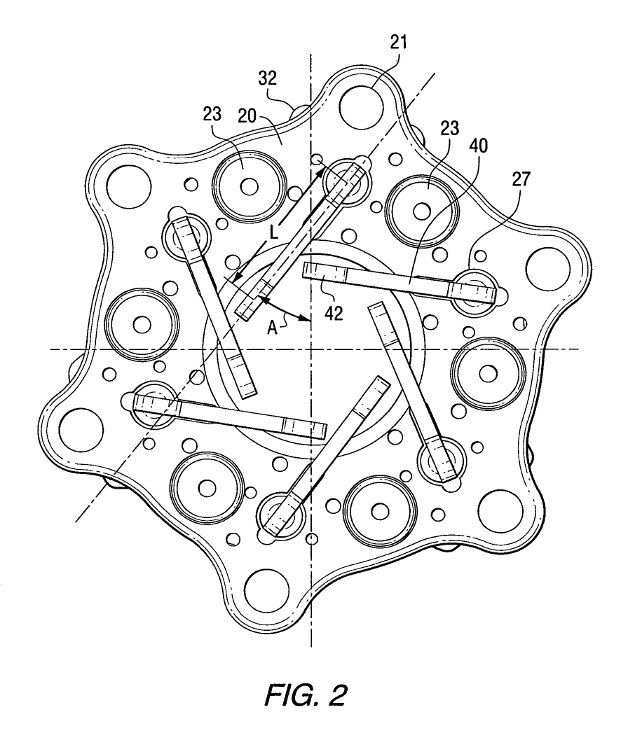

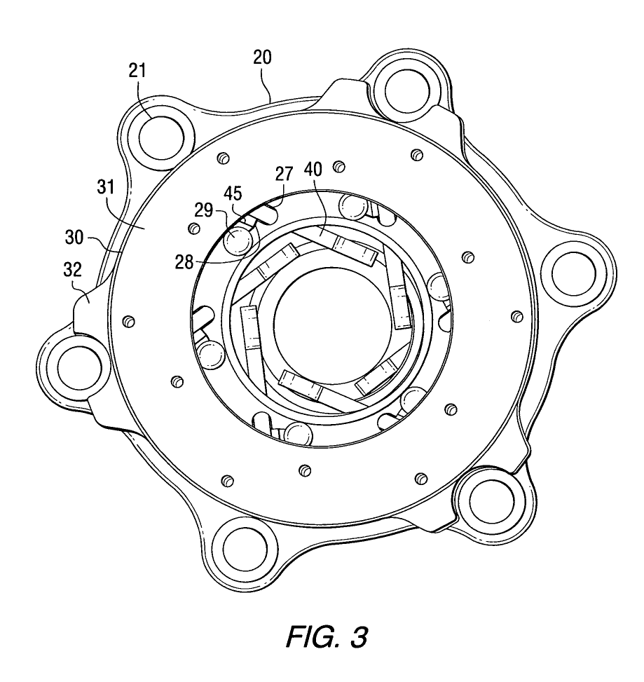

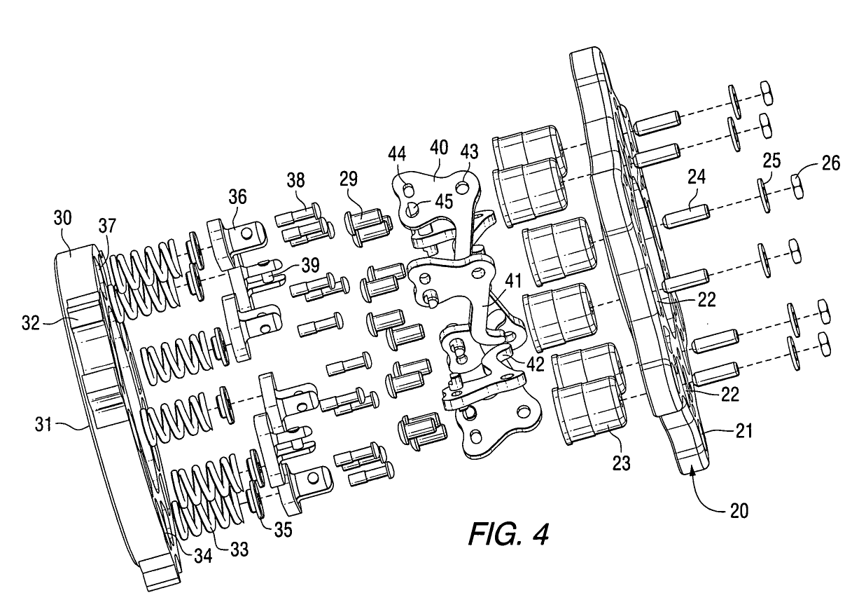

FIG. 1 is an isometric sectional view, FIG. 2 is a top view, FIG. 3 is a bottom view and FIG. 4 is an exploded isometric view of a friction clutch cover and pressure ring assembly 10 in accordance with an embodiment of the present invention. The assembly 10 includes a clutch cover 20, clutch pressure ring 30, and multiple actuating levers 40 pivotally connected to the clutch cover 20 and pressure ring 30.

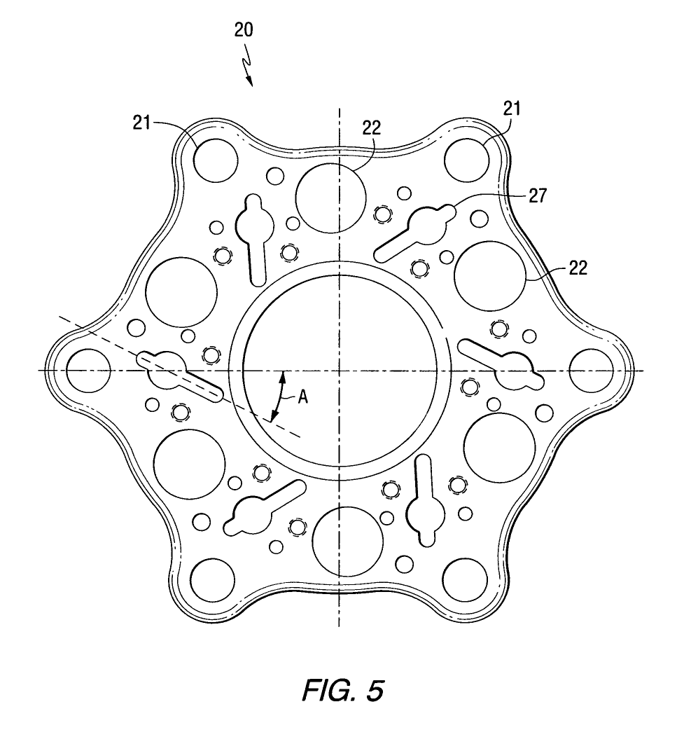

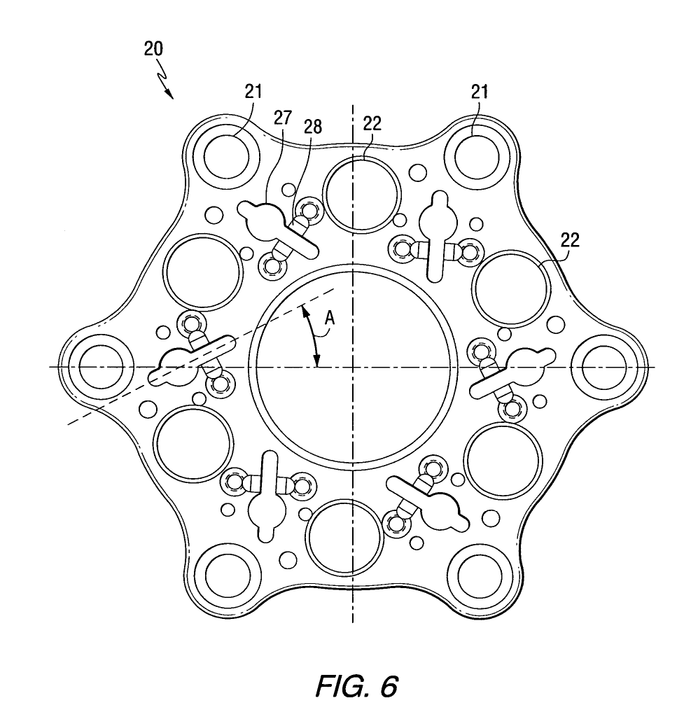

Details of the clutch cover 20 are most clearly shown in FIGS. 2 and 4-6. FIG. 5 is a top view of the clutch cover 20, while FIG. 6 is a bottom view. The clutch cover 20 includes bolt holes 21 which receive conventional clutch bolts (not shown) which connect the clutch cover 20 to a conventional clutch flywheel (not shown), for example, as shown in U.S. Pat. Nos. 4,989,711 and 5,785,163. The clutch assembly may include conventional friction plates, e.g., as described in U.S. Pat. Nos. 4,989,711 and 5,785,163. The clutch cover 20 includes six spring holes 22 which receive spring cups 23. As most clearly shown in FIG. 1, the spring cups 23 extend upwardly through the clutch cover 20. As shown in the exploded view of FIG. 4, a spring bolt 24 is threaded through a hole in the top of each spring cup 23, and a spring washer 25 and nut 26 are secured to each spring bolt 24. As more fully described below, each spring bolt 24 is threaded into a spring cap 35 which is received in the end of a spring 33.

As shown most clearly in FIGS. 1, 2, 5 and 6, the clutch cover 20 includes six slots 27 extending through the thickness of the cover. Each slot 27 includes a circular portion which receives a clevis 36 connected to the pressure ring 30, as more fully described below. Each slot 27 also includes an elongated portion which extends at an angle A offset from a radial direction of the clutch, as shown in FIGS. 5 and 6.

As shown in the bottom view of the clutch cover 20 in FIG. 6, a recess 28 is provided in the bottom surface of the clutch cover 20 extending perpendicularly from the elongated portion of each slot 27. As more fully described below, the generally cylindrical recesses 28 in the bottom surface of the clutch cover 20 receive pins which extend from the actuating levers 40 in order to provide a pivotal connection between the levers 40 and the clutch cover 20. As shown most clearly in FIG. 4, bolts 29 are used to secure the lever 40 with respect to the clutch cover 20, as more clearly described below.

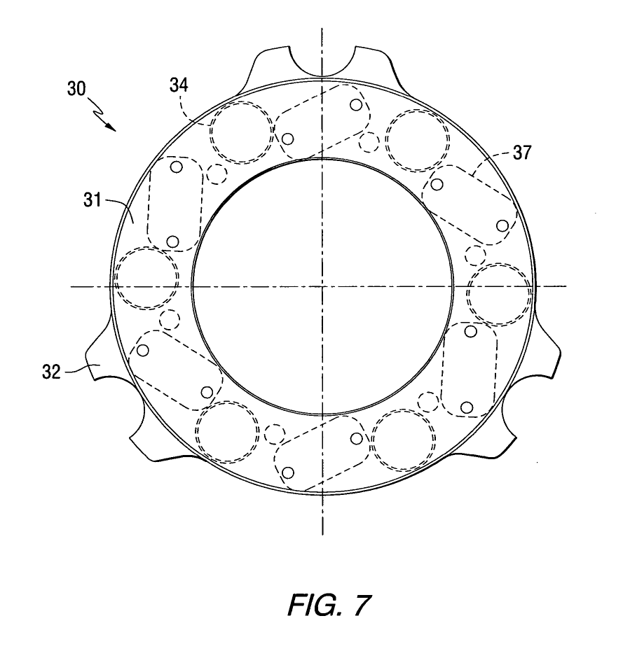

Details of the clutch pressure ring 30 are provided in FIGS. 1, 3, 4 and 7. A heat shield 31 is provided on the lower surface of the pressure ring 30. Radial extensions 32 having semicircular recesses extend radially outward from the generally annular pressure ring 30. In accordance with conventional clutch designs, the recesses of the radial extensions 32 receive conventional clutch bolts (not shown) which extend through the bolt holes 21 of the clutch cover 20 and connect to a conventional clutch flywheel (not shown). The radial extensions 32 thereby prevent relative rotation between the pressure ring 30 and clutch cover 20, while allowing axial movement therebetween.

As shown most clearly in FIGS. 1, 4 and 7, the pressure ring 30 includes cylindrical recesses 34 in which ends of the springs 33 are seated. Spring caps 35 are inserted in the opposite ends of the springs 33. The spring bolts 24 are threaded through holes in the spring caps 35 to help secure the springs 33 within the spring cups 23.

As most clearly shown in FIGS. 1, 4 and 7, six devises 36 are mounted in generally rectangular recesses 37 in the pressure ring 30 and secured by bolts 38. Each clevis 36 includes a generally cylindrical post with a longitudinal slot dividing opposing portions of the post. A pin 39 extends perpendicularly through the slot between the opposing portions of each clevis 36. The post of each clevis 36 is received within the circular portion of a respective slot 27 in the clutch cover 20.

The actuating levers 40 include an arm 41 extending radially inward toward a release tip 42. A hole 43 extends through an upper portion of each actuating lever 40 in order to allow the optional installation of bolts (not shown) or other centrifugal weights which may be used to adjust the amount of centrifugal force applied through the levers 40 during rotation of the clutch assembly. Each actuating lever 40 includes an elongated hole 44 which receives the pin 39 of a respective clevis 36 mounted on the pressure ring 30. Each actuating lever 40 also includes a pin 45 extending from opposite faces of the lever 40 which is received in a respective recess 28 of the clutch cover 20. The pin 45 may be fixedly mounted or rotatably mounted on the lever 40. Each lever 40 is thus pivotally mounted with respect to the pressure ring 30 by means of the hole 44 and clevis pin 39, and is also pivotally mounted with respect to the clutch cover 20 by means of the pins 45 received within the recesses 28. When the lever release tips 42 are forced downward (e.g., by a conventional throw out bearing - not shown), the pressure ring 30 is forced upward toward the clutch cover 20 against the bias of springs 33 to disengage the clutch. When the lever release tips 42 move upward due to centrifugal force generated by the rotating clutch unit, the pressure ring 30 is forced downward away from the clutch cover 20 to increase the clutch engagement force.

As an alternative embodiment, the lever 40 may be pivotally mounted on the clutch cover as shown in the figures, but the pivotal pressure ring mounting 44, 39 may be replaced with direct contact between the lever 40 and the upper surface of the pressure ring, in which case the bottom edge of the lever 40 may act as a cam surface against the pressure ring 30.

In accordance with the present invention, the actuating levers 40 are oriented at offset angles A from the radial direction of the assembly 10. The offset angle A enables the length of the lever arms 41 to be extended beyond the length possible with conventional radial lever designs. As shown in FIG. 2, the length L of each lever 40 measured from its clevis pin mounting hole 44 to its release tip 42 is longer than that possible with conventional radial lever designs. Although the levers 40 shown in FIG. 2 are substantially straight, curved or angled levers may be used.

The lever offset angle A may range from greater than 0° to less than 90°, for example, from about 5° to about 80°. Typically, the lever offset angle may range from about 10° to about 60°, for example, from about 20° to about 40°. For larger diameter clutches, smaller offset angles may be desirable.

The angled lever arrangement of the present invention also provides increased distance between the clevis pin hole 44 and the pin 45 of each actuating lever 40. This increased distance provides an increased lever ratio and an increased axial throw distance between the clutch cover 20 and pressure ring 30. In addition, the angled levers 40 and their respective clevises 36 apply pressure at optimal radial locations around the circumference of the pressure ring in order to achieve an evenly distributed plate load. This is accomplished by allowing the devises 36 to be centrally located C between the inner ID and outer OD diameters of the pressure ring 30, as shown in FIG. 1. This avoids the uneven application of pressure near the outer diameter OD of the pressure ring 30 which can cause uneven wear and decreased performance in conventional clutch designs. Furthermore, the present angled lever arrangement allows the design of smaller diameter, lighter and more efficient clutch units.

Whereas particular embodiments of this invention have been described above for purposes of illustration, it will be evident to those skilled in the art that numerous variations of the details of the present invention may be made without departing from the invention as defined in the appended claims.

1. A clutch cover and pressure ring assembly comprising:
a generally annular clutch cover having a central axis;
a generally annular pressure ring having a central axis substantially aligned with the central axis of the clutch cover, wherein the clutch cover and pressure ring are rotatable with each other around their central axes and axially movable with respect to each other; and
at least one actuating lever pivotally mounted on the clutch cover and/or pressure ring and extending radially inward at an angle offset from a radial direction of the clutch cover and pressure ring.

2. The clutch cover and pressure ring assembly of claim 1, wherein the at least one actuating lever is pivotally mounted on the clutch cover.

3. The clutch cover and pressure ring assembly of claim 2, wherein the at least one actuating lever is pivotally mounted on the pressure ring.

4. The clutch cover and pressure ring assembly of claim 1, wherein the offset angle of the at least one actuating lever is from about 5° to about 80°.

5. The clutch cover and pressure ring assembly of claim 1, wherein the offset angle of the at least one actuating lever is from about 10° to about 60°.

6. The clutch cover and pressure ring assembly of claim 1, wherein the offset angle of the at least one actuating lever is from about 20° to about 40°.

7. The clutch cover and pressure ring assembly of claim 1, wherein the pressure ring has an inner diameter and an outer diameter and the at least one actuating lever applies force to the pressure ring substantially midway between the inner and outer diameters of the pressure ring.

8. The clutch cover and pressure ring assembly of claim 7, further comprising a clevis mounted on the pressure ring substantially midway between the inner and outer diameters of the pressure ring, and the at least one actuating lever is pivotally connected to the clevis.

9. The clutch cover and pressure ring assembly of claim 1, wherein the at least one actuating lever is rotatable due to centrifugal force generated by rotation of the assembly.

10. The clutch cover and pressure ring assembly of claim 9, wherein the at least one actuating lever comprises an arm which rotates upward away from the clutch cover due to the centrifugal force.

11. The clutch cover and pressure ring assembly of claim 10, wherein the upward rotation of the at least one actuating lever forces the pressure ring axially away from the clutch cover.

12. The clutch cover and pressure ring assembly of claim 1, wherein the assembly comprises a plurality of the actuating levers.

13. The clutch cover and pressure ring assembly of claim 1, wherein the assembly comprises at least three of the actuating levers.

14. The clutch cover and pressure ring assembly of claim 1, wherein the assembly comprises six of the actuating levers.

15. The clutch cover and pressure ring assembly of claim 1, wherein the clutch cover comprises at least one slot through which the at least one actuating lever extends, and the at least one slot extends radially inward at an angle offset from the radial direction of the clutch cover.

16. The clutch cover and pressure ring assembly of claim 15, wherein the offset angle of the at least one slot is the same as the offset angle of the at least one actuating lever.

17. The clutch cover and pressure ring assembly of claim 15, wherein the clutch cover comprises at least three of the slots.

18. An annular clutch cover having a central axis and comprising a plurality of slots structured and arranged for receiving actuating levers, wherein each slot extends radially inward at an angle offset from a radial direction of the clutch cover.

19. An annular clutch pressure ring having a central axis and comprising a plurality of recesses structured and arranged to receive actuating levers, wherein each recess is oriented at an angle offset from a radial direction of the pressure ring.

20. The annular clutch pressure ring of claim 19, further comprising a clevis mounted in each of the recesses structured and arranged for pivotal mounting of one of the actuating levers at an angle offset from the radial direction of the pressure ring.
